(19) United States
(12) Patent Application Publication
(10) Pub. No.: US 2011/0262314 A1
(43) Pub. Date: Oct. 27, 2011

(54) DEVICE FOR PRODUCING HYDROGEN FROM A PLASMA WITH ELECTRON CYCLOTRON RESONANCE

(75) Inventors: Denis Hitz, Grenoble (FR); Marc-Yves Delaunay, Meylan (FR)

(73) Assignee: Commissariat a L'energie atomique et aux energies alternatives, Paris (FR)

(21) Appl. No.: 13/121,533

(22) PCT Filed: Sep. 29, 2009
(86) PCT No.: PCT/FR2009/051843

§ 371 Date: Jun. 9, 2011

(30) Foreign Application Priority Data
Sep. 30, 2008 (FR) 0856614

(51) Int. Cl. B01J 19/12

(52) U.S. Cl. 422/186.01

(57) ABSTRACT

A device for producing hydrogen from electron cyclotron resonance plasma, includes a sealed vacuum chamber to contain plasma, a water vapor injector to inject water vapor into the chamber, a generator to generate a high-frequency wave that is provided inside the chamber, a magnetic structure to generate a magnetic field in the chamber and to generate a plasma surface along the magnetic field lines, the module of the magnetic field presenting a magnetic mirror configuration with at least one electron cyclotron resonance zone to at least partially dissociate water molecules introduced in vapor phase and to at least partially ionize the products of dissociation, a cryogenic condenser, placed in the sealed chamber to freeze oxygen coming from the dissociation without freezing hydrogen coming from the dissociation, a hydrogen recovery unit to recover the hydrogen coming from the dissociation, the oxygen being trapped by the cryogenic condenser.

The present invention relates to a device for producing hydrogen from electron cyclotron resonance plasma.

Today hydrogen (H₂) appears to be an energy vector of great interest, which is called to take on more and more importance and which may, eventually, advantageously be substituted for petroleum and fossil fuels, whose reserves will significantly decrease in the decades to come. In this perspective, it is necessary to develop effective methods to produce hydrogen.

Admittedly, many methods for producing hydrogen from various sources have been described, but a number of these methods have turned out to be unsuitable with regard to the limitation of greenhouse gases.

A first technique consists of using water vapor reforming. This is a technique for transforming light hydrocarbons such as methane into synthesis gas by reaction with water vapor on a catalyst. The two main chemical reactions of this method are the production of synthesis gas and the conversion of CO:

CH₄+H₂O→CO+3H₂

CO+H₂O→CO₂+H₂

the overall result being

CH₄+2H₂O→CO₂+4H₂

One of the main problems with this synthesis route is that it produces, as by-products, significant quantities of CO₂-type greenhouse gases.

A second method consists of using a partial oxidation technique: This is an exothermal technique, generally without oxidation catalyst, for products such as natural gas, heavy oil residues and coal. The production of synthesis gas is given by the reaction:

CₙHₘ+(n/2)O₂→nCO+(m/2)H₂

The conversion of carbon monoxide is given by the reaction:

nCO+nH₂O→nCO₂+nH₂

As with reforming, this technique produces a significant quantity of carbon dioxide.

Mention may also be made of a third technique using the direct thermal decomposition of water; such a technique would necessitate extremely high temperatures on the order of 3000 to 4000 K (the use of a catalyst enables this temperature to be reduced, which would, however, remain very high, approaching 1400 K). This production technique is considered by utilizing high-temperature nuclear reactors cooled by a gaseous coolant such as helium (the case of HTR “High Temperature Reactor” type, fourth generation reactors). By virtue of its principle, this technique is connected to uranium production. The other disadvantage is that using this method for producing small amounts of hydrogen is unthinkable.

A fourth pathway consists of carrying out water electrolysis: this is a technique of dissociating water by the passage of an electric current according to the reaction:

$${H}_{2} O -> {H}_{2} + \frac{1}{2} {O}_{2}$$

This reaction, in which the enthalpy is ΔH=285 kJ·mol⁻¹ (at 298K and 1 bar) is carried out according to the following method: An electrolyte cell is constituted of two electrodes, an anode and a cathode, connected to a direct current generator. The electrodes are immersed in an electrolyte used as a electrical conductor. In general, this electrolyte is an acid or basic aqueous solution, a polymeric proton exchange membrane (H⁺) or an oxygen ion conductive membrane (O²⁻).

However, this technique poses certain difficulties; thus the electrodes corrode over time. In addition, such a method necessitates the ongoing adjustment of concentrations and the use of membranes that are either fragile for organic membranes, or have a low yield for mineral membranes.

A fifth solution consists of water decomposition by thermochemical cycle (TCC): This method uses a series of chemical reactions. One example is the use of the iodine-sulfur cycle based on the decomposition of two acids at high temperature: sulfuric acid produces oxygen and sulfur dioxide, and hydroiodic acid produces hydrogen and iodine.

The disadvantage of this technique is the implementation of rather complex chemical reactions producing, in addition to hydrogen, many other elements, such as sulfur in the case of the iodine-sulfur cycle or Fe₃0₄ and HBr in the case of the UT-3 cycle.

A sixth pathway considered is the biomass: Obtained by the photosynthesis of carbon dioxide and water, it uses solar energy to produce C₆H₉O₄ molecules. Then there is a thermochemical treatment according to the reaction:

C₆H₉O₄+2H₂O+880 kJ→6CO+13/2H₂

Gasification to water vapor around 900° C. then produces synthesis gas (CO+H₂0). A hydrogen supplement is then obtained by the “gas shift” reaction.

6CO+6H₂O→6CO₂+6H₂

Again, the main disadvantage of this technique resides in its production of carbon dioxide.

A seventh technique consists of carrying out photoelectrolysis of water: This is a process that uses the dissociation of the water molecule by an electric current produced by illuminating a semiconductor photocatalyst (Ti0₂, AsGa).

This process does not produce greenhouse gas but has relatively a low conversion efficiency.

Another method to produce hydrogen gas by microwave plasma is proposed in document WO2006/123883. This method uses the dissociation of gaseous molecules by electron impact. The method disclosed consists of injecting microwave power into a dielectric tube containing an H₂0 or CH₄ type gas or vapor under reduced pressure (50-300 torr). This microwave power causes the ionization and/or dissociation of gas by thus releasing hydrogen (initiating microwave plasma). At the end of the tube, a separator in a palladium type material separates the hydrogen by gaseous diffusion.

Another method to produce hydrogen from water molecules is described in document WO2005/005009. The method disclosed consists of placing water molecules in an electromagnetic field to excite the molecules by thermal agitation until their excitation energy exceeds the bond energy of the H and O atoms composing the water molecule.

Another method of producing hydrogen by injecting water vapor in plasma is described in document US2004/0265137. This patent describes a method of obtaining hydrogen from vapor dissociated in plasma. The document notably mentions the use of electron cyclotron resonance (ECR) to produce said plasma. With relation to the hydrogen production methods previously cited, the use of an ECR plasma machine presents many advantages:
continuous and stable operation;
no implementation of high temperatures;
no wear (very long operating time due to the absence of filament or electrodes);
no production of carbon or carbon compounds;
no utilization of chemical complexes;
low cost, if the magnetic structure is made of permanent magnets.

However, despite the advantages mentioned above, a major problem with a plasma machine that breaks, by electron impact, water molecule bonds is the separation of the products formed.

Inserting a dielectric is a possible solution. However, this method presents the disadvantage of using rare and costly compounds.

In this context, the object of the present invention is to provide a device for producing hydrogen from water with electron cyclotron resonance plasma not necessarily requiring significant magnetic fields and enabling effective dissociation of the water molecules and simple separation of the products formed.

For this purpose, the invention proposes a device for producing hydrogen from electron cyclotron resonance plasma comprising:
a sealed vacuum chamber intended to contain plasma,
means for injecting water vapor into said chamber,
means for injecting a high-frequency wave inside said chamber,
a magnetic structure for generating a magnetic field in said chamber and generating a plasma surface along the magnetic field lines, the module of said magnetic field presenting a magnetic mirror configuration with at least one electron cyclotron resonance zone to at least partially dissociate the water molecules introduced in vapor phase and to at least partially ionize the products of dissociation,
   said device being characterized in that it comprises:
at least one cryogenic condenser, placed in said sealed chamber, to freeze the oxygen coming from the dissociation without freezing the hydrogen coming from the dissociation,
means for recovering the hydrogen coming from the dissociation, the oxygen being trapped by said cryogenic condenser.

Sealed vacuum chamber is understood to refer to a chamber in which a working pressure of less than or equal to 5.10⁻³ mbar exists, said working pressure substantially corresponding to the partial pressure of water vapor injected into the chamber.

Thanks to the invention, hydrogen is produced from water vapor. The device according to the invention is based on the combined use of electron cyclotron resonance plasma and at least one selective cryogenic condenser. This non-C0₂ emitting device does not use electrodes, membranes or high temperatures.

Thanks to the principle of electron cyclotron resonance, at every passage in the vicinity of the resonance zone, the electrons will acquire energy. They will then be able to dissociate the water molecules and then ionize, at least partially, the products of dissociation. Thanks to the electroneutrality of plasma, these ions will follow the electrons along the magnetic field lines.

The device according to the invention enables work to continue for several months without interruption or maintenance. The device may, depending on its dimensions, have a plasma volume ranging from some cm³ to several liters, or even m³.

By observing the phase diagrams of the hydrogen and oxygen elements for the low temperatures represented in FIG. 2, the operating pressure of the plasma machine under consideration being less than 5.10⁻³ mbar, it is noted that a temperature range where it is possible to cryocondense oxygen while keeping hydrogen in gaseous form exists. For example, at 5.10⁻³ mbar, this temperature range goes from 6.4K to 42K. Thus, by using one or more cryogenic condensers (for example one or more cooled plates) at a temperature such that the two elements, hydrogen and oxygen, composing the plasma are in different phases (gaseous hydrogen and solid oxygen), the oxygen may be trapped in solid form without trapping the hydrogen, that will be recovered by other means. The temperature of the condenser depends on the partial hydrogen pressures from the initial density of the plasma that is itself a function of the microwave frequency injected. The oxygen being trapped, means to recover the hydrogen are then used, such as a conventional pumping system (a turbomolecular pump, for example) to pump the hydrogen. It is also possible to advantageously use the fact that the ionized particles follow, by plasma electroneutrality, the electrons that are guided by the magnetic field lines. In fact, if the oxygen cryocondensation plates are placed in the magnetic field lines, hydrogen cryocondensation plates may then advantageously be placed outside the magnetic field lines. Thus, as hydrogen and oxygen set on the independent cold walls, one or the other only has to be heated independently to recover the hydrogen and oxygen separately, either in liquid form or in gaseous form.

It will be noted that, although an electromagnetic field is used, the device according to the invention does not use the water molecule thermal agitation method, but breaks the atomic bonds by collisions with plasma electrons.

According to a particularly advantageous embodiment of the invention, said chamber comprises means to recover the non-dissociated water, the field lines generated by said magnetic structure being curved with relation to the axis of injection of the water vapor, said non-dissociated water recovery means being substantially arranged along the axis of injection of the water vapor.

This advantageous embodiment enables the problem of recovering water molecules not dissociated by plasma electrons to be resolved. In fact, the ionization and dissociation of water molecules is never complete; consequently, a considerable quantity of water molecules remain present. Obviously, it is of interest to recover these non-dissociated water molecules, for example to recycle them by returning them to the chamber in vapor form. If the magnetic field lines were not curved, it would not be possible to recycle the non-dissociated water. Indeed, the non-dissociated water molecules are not guided by the magnetic field lines and preferentially go in a straight line with relation to the water vapor injection nozzle. In other words, in a simple axisymmetric mirror, the non-dissociated water as well as the dissociated hydrogen and oxygen should be recovered at the same place and at the same time, which is difficult to carry out.

According to this advantageous embodiment, the magnetic field lines are curved such that it is then possible to perform, at the same time, non-dissociated water recycling, hydrogen and oxygen separation, hydrogen recovery and oxygen recovery operations. The curved magnetic field lines thus enable the non-dissociated and non-ionized water vapor, for example on a condenser placed in a straight line with relation to the water vapor injection, to be recovered.

The device according to the invention may also present one or more of the characteristics below, considered individually or according to all technically possible combinations:
said non-dissociated water recovery means comprise a second chamber connected to said plasma chamber;
said second chamber is in tubular form;
said non-dissociated water recovery means are formed by a condenser;
said non-dissociated water recovery means are separated from said plasma chamber by a diaphragm device;
the device according to the invention comprises at least one system for reinjecting non-dissociated water in vapor phase and coming from said non-dissociated water recovery means;
the device according to the invention comprises a screen presenting a mesh allowing the propagation of high-frequency waves to be stopped such that said non-dissociated water recovery means are arranged in a zone without microwaves and thus substantially without plasma;
said cryogenic condenser to freeze the oxygen coming from the dissociation without freezing the hydrogen coming from the dissociation is at a temperature of between 6 and 41K for an average pressure of between 10⁻³ mbar and 5·10⁻³ mbar in said chamber (temperature of between 6 and 39 K for a pressure substantially equal to 10⁻³ mbar and temperature of between 6 and 41K for a pressure substantially equal to 5·10⁻³ mbar);
said cryogenic condenser to freeze the oxygen is a solid or openwork cryogenic panel;
said cryogenic condenser to freeze the oxygen is arranged so as to intercept said field lines formed by said magnetic structure;
said cryogenic condenser to freeze the oxygen is a cryogenic panel that surrounds said field lines formed by said magnetic structure;
the device according to the invention comprises an enclosure able to recover oxygen when said cryogenic condenser to freeze the oxygen is regenerated by increasing the temperature;
said means for recovering hydrogen coming from the dissociation comprise a pump used to pump hydrogen in gaseous phase;
said means to recover hydrogen coming from the dissociation comprise at least one cryogenic condenser to freeze hydrogen, said cryogenic condenser being at a temperature less than the temperature of said at least one cryogenic condenser to freeze the oxygen, said at least one cryogenic condenser to freeze the oxygen being arranged so as to trap the oxygen before said at least one cryogenic condenser to freeze the hydrogen traps the hydrogen.
the device according to the invention comprises:
   a cryogenic condenser to freeze the hydrogen able to be regenerated by increasing the temperature,
   an enclosure able to recover the hydrogen when said cryogenic condenser to freeze the hydrogen is regenerated by increasing the temperature;
the device according to the invention comprises:
   a first enclosure including:
      a first cryogenic condenser to freeze the oxygen;
      possibly, a first cryogenic condenser to freeze the hydrogen;
   a second enclosure including:
      a second cryogenic condenser to freeze the oxygen;
      possibly, a second cryogenic condenser to freeze the hydrogen;

Each of said first and second enclosures being able to recover oxygen and hydrogen independently from each other by regeneration, said regeneration is done by progressive increase in the temperature so that the hydrogen first passes in gaseous phase and is recovered and the oxygen then passes into gaseous phase and is recovered.
said at least one cryogenic condenser to freeze the hydrogen comprises at least one solid or openwork cryogenic panel;
the device according to the invention comprises a negatively polarized screen placed in front, with relation to the plasma, of said at least one cryogenic condenser to freeze the hydrogen and/or said at least one cryogenic condenser to freeze the oxygen, such that said screen pushes the electrons towards the plasma and attracts the ions;
said at least one cryogenic condenser to freeze the hydrogen and/or said at least one cryogenic condenser to freeze the oxygen are able to be negatively polarized to push the electrons towards the plasma and attract the ions;
said means to recover the hydrogen coming from the dissociation are arranged so as to not intercept said magnetic field lines;
the device according to the invention comprises at least one catalyst surface to set the water molecules and increase the yield of water dissociation by electron impact of the plasma on said surface;
said catalyst surface is placed in the magnetic mirror zone, preferably between the resonance zones.
said magnetic structure comprises permanent magnets;
the magnetic structure comprises permanent magnets in which the poles facing each other in the water vapor injection zone are the same North-North or South-South type;
the magnetic structure comprises permanent magnets in which the poles facing each other in the hydrogen recovery zone have the same direction, the magnetization values of these magnets being either identical or different;
the magnetic structure comprises permanent magnets in which the poles facing each other in the hydrogen recovery zone have opposite directions;
the permanent magnet located in the water vapor injection zone has the same polarity as the magnet located in the hydrogen recovery zone;
the magnetic structure comprises permanent magnets of different sizes and presenting either a same magnetization or different magnetizations;
the magnetic structure comprises coils at ambient temperature and/or superconducting coils at low or high critical temperature, called low or high Tc;
the entrance window of said high-frequency wave propagation means inside said chamber is placed in a magnetic field whose module is greater than the module of the magnetic field resonance so that the plasma diffuses towards the chamber and thus prevents the impact of plasma on said window;
the mirror ratio between the magnetic field maximum of said magnetic mirror and the magnetic field minimum of said magnetic mirror is strictly greater than 1 and preferentially greater than 3, that represents an optimal value to enable good plasma confinement.

Other characteristics and advantages of the invention will clearly emerge from the description given below, for indicative and in no way limiting purposes, with reference to the attached figures, among which:

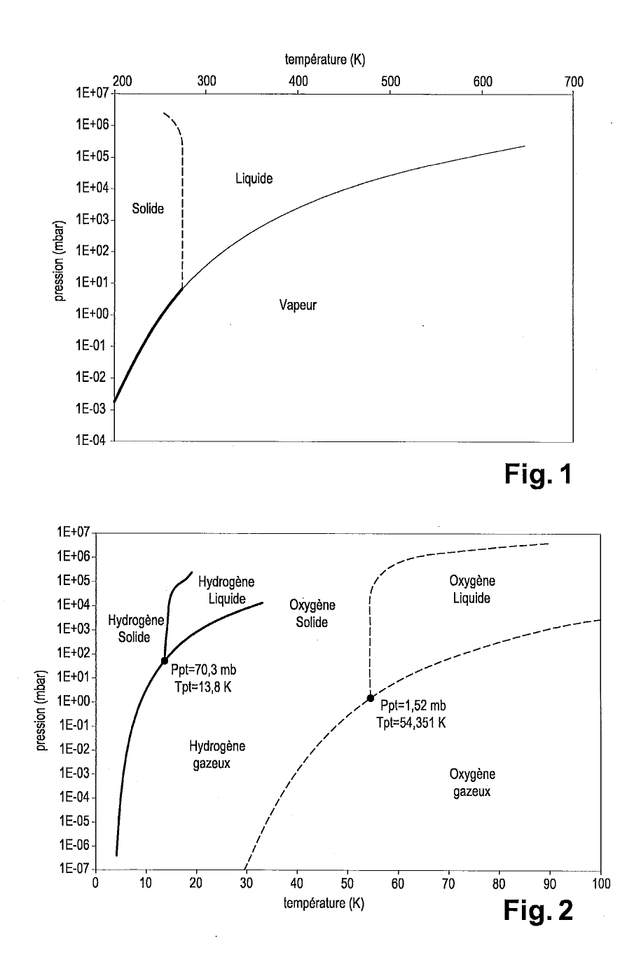

FIG. 1 is a representation of the water phase diagram;

FIG. 2 is a representation of the hydrogen and oxygen phase diagrams with values corresponding to the triple point of each element;

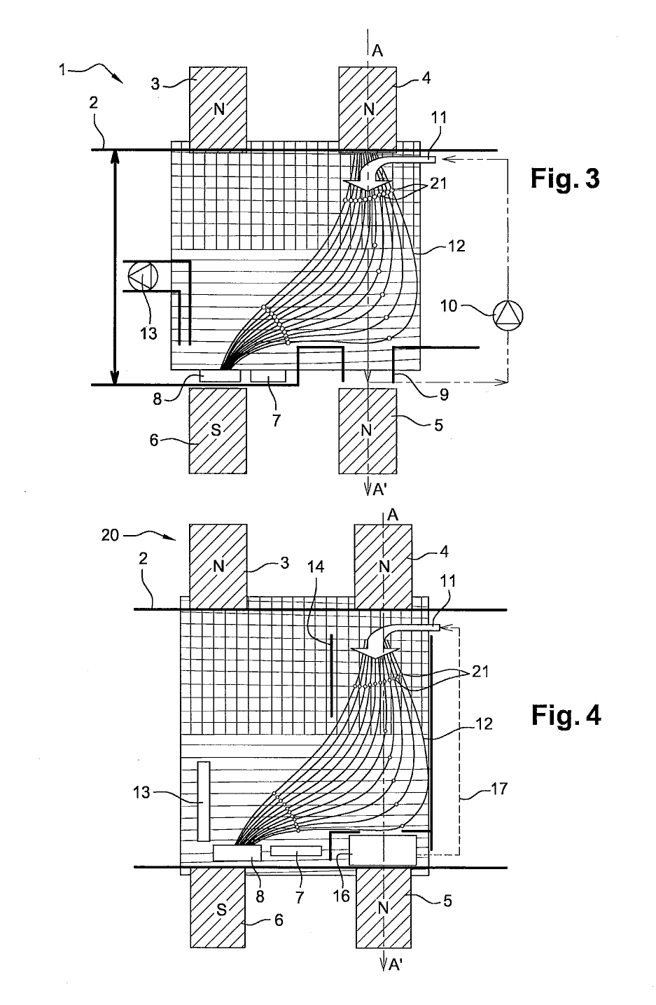

FIG. 3 represents in top view a first embodiment of the device according to the invention;

FIG. 4 represents in top view a second embodiment of the device according to the invention;

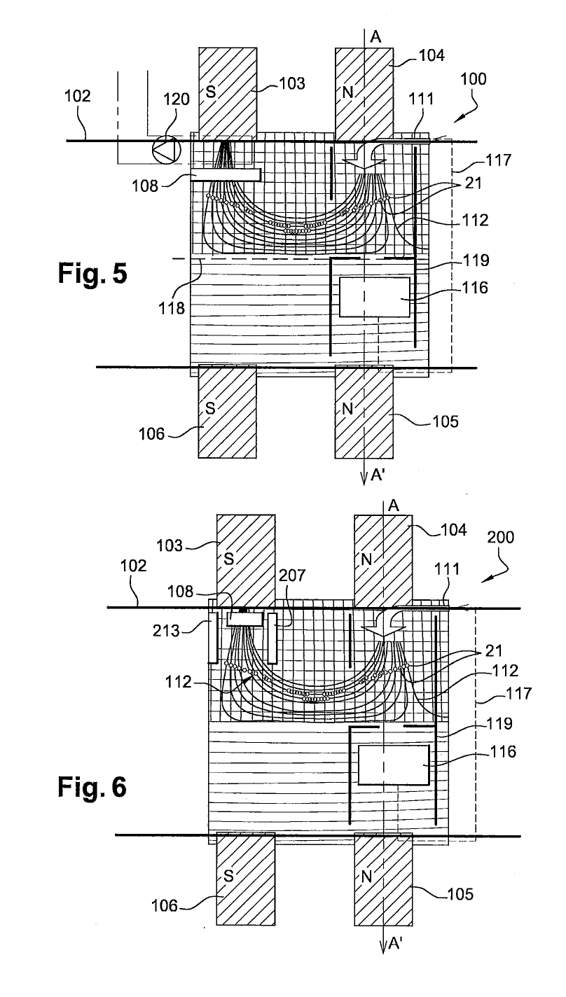

FIG. 5 represents in top view a third embodiment of the device according to the invention;

FIG. 6 represents in top view a fourth embodiment of the device according to the invention;

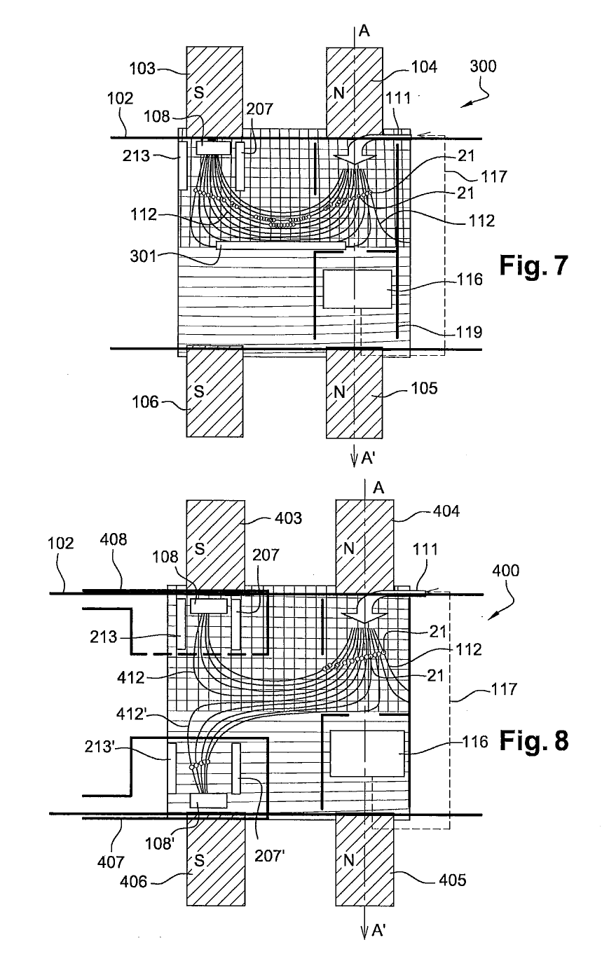

FIG. 7 represents in top view a fifth embodiment of the device according to the invention;

FIG. 8 represents in top view a sixth embodiment of the device according to the invention;

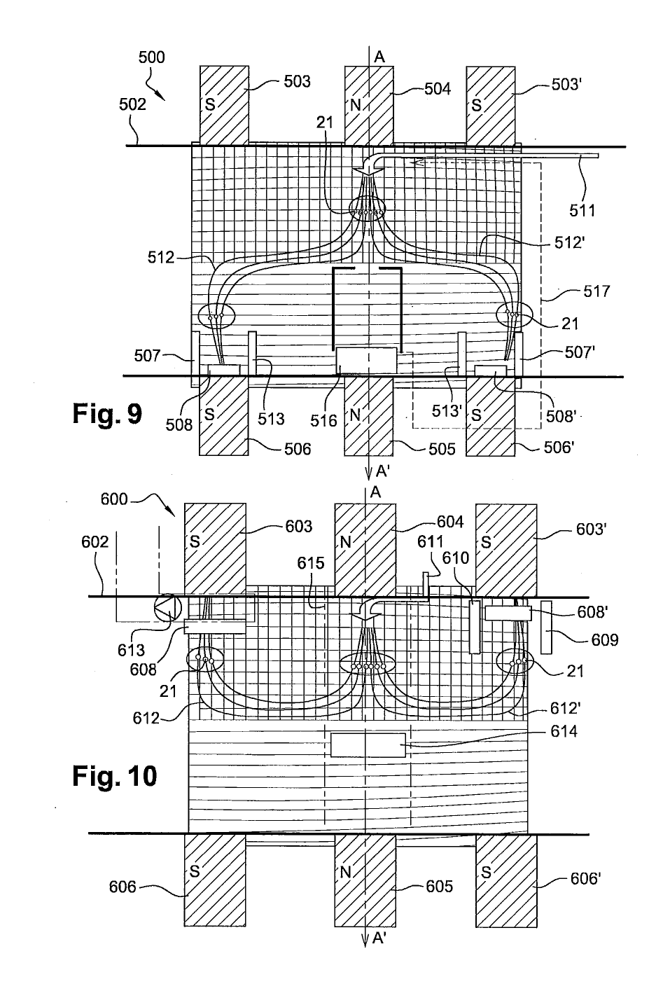

FIG. 9 represents in top view a seventh embodiment of the device according to the invention;

FIG. 10 represents in top view an eighth embodiment of the device according to the invention;

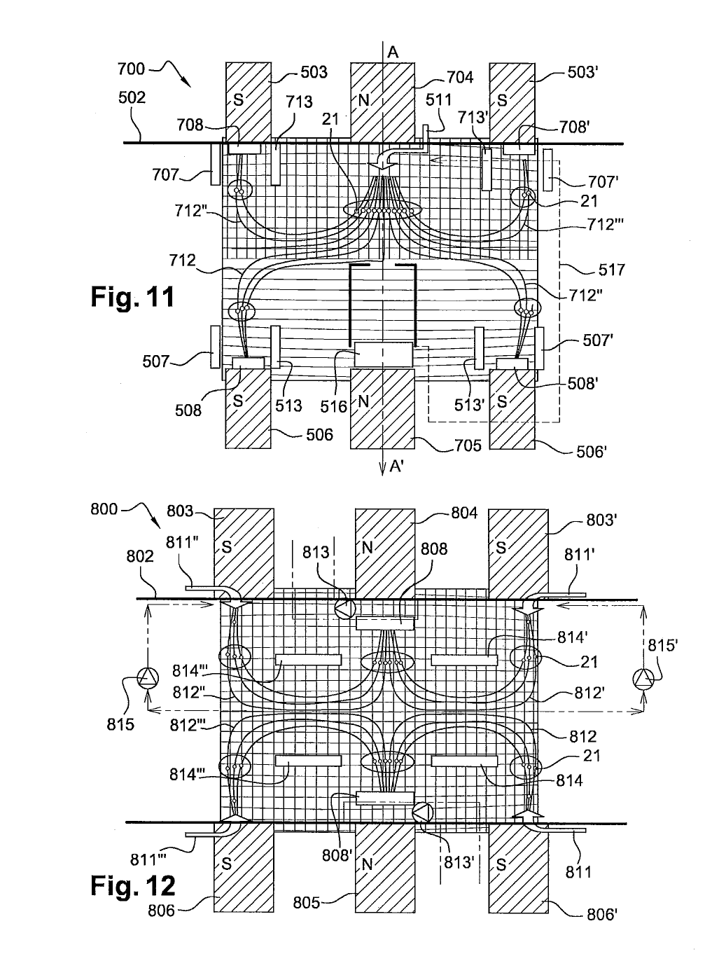

FIG. 11 represents in top view a ninth embodiment of the device according to the invention;

FIG. 12 represents in top view a tenth embodiment of the device according to the invention.

In all figures, common elements bear the same reference numbers.

FIGS. 1 and 2 have already been described with reference to the general presentation of the invention.

FIG. 3 is a simplified representation in top view of a device 1 for producing electron cyclotron resonance hydrogen according to a first embodiment of the invention. The device 1 comprises:
a sealed vacuum chamber 2 (also called enclosure subsequently);
four permanent bar magnets 3, 4, 5 and 6 placed outside chamber 2 (the bars typically have a height of between some centimeters and 1 m);
a cryogenic condenser 8 to trap the oxygen;
a condenser 7 to trap the hydrogen;
a pump 13 for pumping the gaseous hydrogen;
tubing 9 for recovering non-dissociated water acting as a water vapor condenser;
a pump 10 for recycling non-dissociated water in vapor or liquid phase;
means for injecting water vapor inside chamber 2 and means for propagating high-frequency waves (formed by a waveguide or a coaxial cable equipped with a vacuum tight high-frequency window, not represented) inside chamber 2, said injecting and propagating means being illustrated by arrow 11 and being located near magnet 4.

Chamber 2 is under vacuum, the vacuum being achieved by pumping means. In order to have the fewest impurities possible in chamber 2, a residual vacuum of 10⁻⁴ mbar minimum is necessary. However, this vacuum (typically up to 10⁻⁵ mbar) may be lowered further to have even fewer impurities in chamber 2. During the operation of device 1 (i.e., after injection of water vapor in the chamber), the working pressure of chamber 2 is typically less than or equal to 5.10⁻³ mbar, this pressure being connected to the partial pressure of water vapor injected into chamber 2.

The magnetic structure formed by the four bars 3, 4, 5, and surrounding chamber 2 produces inside chamber 2 a magnetic field whose configuration is a magnetic mirror configuration presenting at least two magnetic field maxima and one magnetic field minimum and at least one resonance zone (here a plurality of resonance zones represented by white dots 21 located on field lines 12). It is a structure known as minimum B: The plasma electrons are confined in magnetic well.

In a magnetized plasma device such as device 1, the electrons are well confined, particularly those that have a high perpendicular velocity with relation to the magnetic field lines. When microwaves are injected into the plasma, they tend to propagate through the plasma up to the resonance zone. In fact, the energy transfer of the injected microwave power to the plasma electrons is produced at a magnetic field location Bᵣₑₛ such that the electron cyclotron resonance condition is established, i.e., when there is equality between the high frequency wave HFW pulse and the cyclotron pulse of the electron:

ω_{HF}=ω_{ce}=qₑBᵣₑₛ/mₑ

A microwave generator, not represented, is placed outside chamber 2; this generator injects high-frequency (HF) waves into chamber 2 via the aforementioned propagation means. The frequency range of the microwaves may go from the GHz to a hundred GHz, the most common generator being the magnetron at 2.45 GHz, commonly used for domestic microwave ovens. For a frequency of 2.45 GHz, there is a magnetic resonance field Bᵣₑₛ=0.0875 T. However, for miniature hydrogen production devices (for embedded systems, for example), power transistors may also be used as HF generators. In fact, field effect transistors capable of delivering approximately 60 W at 14.5 GHz now exist.

The means for injecting water vapor into chamber 2 are preferentially placed near the microwave generator means (however, another location may also be chosen for reasons of convenience). The water is introduced in plasma chamber 2 in vapor phase. A simple means to obtain this vapor phase is to depress a water reservoir to some dozen mbar.

Thanks to the principle of electron cyclotron resonance, at every passage in the vicinity of the resonance zone, the electrons will, acquire energy. They will then be able to dissociate the water molecules, and then at least partially ionize the products of dissociation. The electrons follow the magnetic field lines thanks to Laplace's law; thanks to the electroneutrality of plasma, these ions will follow the electrons along magnetic field lines 12.

The best water dissociation rates being obtained for working pressures of less than 5.10⁻³ mbar, this value is considered to be a maximum working pressure in enclosure 2, all the more so as the electrons would not be magnetically guided if this pressure is increased beyond 5.10⁻³ mbar.

In the case of interest to us, i.e., the production of hydrogen from water vapor, only the electron population having some dozens eV is useful. At the working pressure under consideration, the energy distribution of electrons goes from some eV to some dozen eV, this distribution being sufficiently large to reach the desired ionization objective.

Advantageously, the high-frequency wave entrance window (represented by the end of arrow 11) is placed in a strong magnetic field zone. In this way, the plasma will diffuse in the plasma chamber and not towards the HF window that will then have an unlimited lifetime. Using “overdense” plasmas, where the plasma frequency is greater than the microwave frequency, is also possible. The use of “overdense” plasmas enables the electronic density to be advantageously increased and thus the system efficiency to be increased.

Water vapor is injected substantially following the vertical AA′ axis in the plane of the sheet by the injection means.

The orientation of magnets 3, 4, 5 and 6 is such that, at the location where the water vapor and microwaves are injected (between the two magnets 4 and 5), two identical polarities face each other: Thus the two magnets 4 and 5 have a same north polarity (of course, the invention also applies with a same south polarity). Conversely, at the hydrogen recovery location (between the two magnets 3 and 6), the polarities that are facing each other have opposed signs: Thus, magnet 3 has a north polarity and magnet 6 has a south polarity. In addition, the polarities of the magnets located, on the one hand, on the water vapor injection side (magnet 4 having a north polarity) and, on the other hand, on the hydrogen recovery side (magnet 6 having a south polarity) have opposed signs. Consequently, the magnetic field lines 12 are curved, thus enabling the non-dissociated and non-ionized water vapor to be recovered on water condenser 9 placed near magnet 5, in a straight line with relation to the AA′ water vapor injection axis. If the magnetic field lines 12 were not curved, it would not be possible to recycle the non-dissociated water. Indeed, the non-dissociated water molecules are not guided by the magnetic field lines and preferentially go in a straight line with relation to the water vapor injection. In other words, in a simple axisymmetric mirror, the non-dissociated water as well as the dissociated hydrogen and oxygen should be recovered at the same place and at the same time, which is difficult to carry out.

The tubular water condenser 9 is placed directly in enclosure 2 in which a pressure on the order of 10⁻³ mbar exists. FIG. 2, that represents a water phase diagram, shows that at the pressure under consideration, non-dissociated water is always in vapor form for temperatures greater than 200K, which is the case in plasma chamber 2. Here, this condenser 9 is vertical tubing in which a pressure gradient is established (from 10⁻³ mbar to 10² mbar or 1 bar). Thus the water, that passes from vapor form to liquid form, flows along the vertical tubing 9 by gravity and is advantageously recycled via recycling pump 10. However, if the recycling tubing 9 is short, the pressure gradient in the tubing may remain low and the water may be reinjected in device 1 directly in vapor phase.

The ions created are guided along field lines 12.

At this stage, device 1 according to the invention must separate the various products formed so as to extract the hydrogen. To do this, phase diagrams for the hydrogen and oxygen elements are advantageously used for the low temperatures, such as represented in FIG. 1. As the operating pressure of enclosure 2 under consideration is less than 5.10⁻³ mbar, it is noted that for a temperature of between 6K and 40K (preferentially between 5K and 30K), it is possible to cryocondense oxygen while keeping the hydrogen in gaseous form. Thus, according to the invention, one or more plates cooled to a temperature such that the two elements making up the plasma (oxygen and hydrogen) are in different phases (gaseous hydrogen and solid oxygen) is or are inserted in an extremity of device 1. The temperature is determined by calculating the partial hydrogen pressures from the initial density of the plasma, which is correlated with the microwave frequency injected. The temperature is also determined to minimize the electrical consumption of the cryocooler: the temperature will preferentially be around 30K.

In application of the previous, oxygen condenser 8 is a solid or openwork cryopanel (or cryogenic panel) arranged at the end of magnetic field lines 12. Thus, the plasma that follows these field lines thanks to its electroneutrality arrives close to wall 8, whose temperature is near, for example, 20-30K. All the particles are thus trapped, except for the hydrogen, which will remain in gaseous phase. It will be noted that the various components coming from the dissociation of water are essentially: H₂, 0₂, OH, H, O, 0⁺, H⁺, H₂⁺, 0₂⁺, OH⁻. All the ionized elements cancel each other out before touching a wall (either a cryopanel wall or another wall), while the neutral elements recombine to give stable elements: H₂, O₂, H₂0.

A condenser 7 has cold walls (at a temperature of less than 5K and different from the temperature of condenser 8) such that a solid or openwork cryopanel is placed outside of the magnetic field lines to cryocondense hydrogen. Thus, hydrogen and oxygen set on the independent cold walls (respectively, condenser 7 to recover hydrogen and condenser 8 to freeze the oxygen without freezing the hydrogen) such that one or the other wall(s) only has to be heated independently to recover the hydrogen and oxygen separately, either in liquid form or in gaseous form.

Pump 13 for pumping gaseous hydrogen is located outside of field lines 12 near the end of field lines 12.

Thus, at field lines 12, condenser 8, whose temperature is on the order of 20-30K, traps the oxygen from the plasma. At this temperature, the hydrogen is not trapped, remains gaseous and may thus be pumped via pumping means 13.

Thus it is observed that two types of means to recover the hydrogen coming from the dissociation may be used, the oxygen being trapped by said cryogenic condenser 8: A cryogenic condenser 7 and/or pumping means 13.

It will be noted that, according to the grid represented in FIG. 3, one square substantially corresponds to 1 cm; Consequently, the width of the microwave injection window is on the order of 2 cm (this scale is valid for all of FIGS. 3 to 15). However, it should be noted that one will not depart from the scope of the invention by adopting different dimensions, particularly higher dimensions. The dimensions of each magnet have been calculated so as to obtain, in the plasma chamber, resonance zones, where the electrons take on enough energy to dissociate the water molecules and at least partially ionize the products of dissociation. Thus, for the 2.45 GHz frequency, the magnets typically have a width of 5.4 cm and a length of 6.5 cm (this is an example of embodiment but it may, of course, have other combinations at a given frequency). As for the height, it is defined by the person skilled in the art according to the available space and his needs. In fact, the height may go from some centimeters to several meters.

FIG. 4 is a variation of the previous figure (the means in common between devices 1 and 20 bear the same reference numbers and carry out the same functions). Device 20 according to this second embodiment is differentiated from device 1 of FIG. 3 in that it comprises a non-dissociated water condenser 16, said condenser 16 being cooled, for example with liquid nitrogen (at 77K) so as to set the water in ice form (to save electrical energy, the liquid water at some ° C. may thus be recycled). The condenser 16 is arranged near magnet 5, in a straight line with relation to the water vapor injection axis AA′.

In this case, the person skilled in the art will carry out a heating cycle: without stopping the microwave injection, but by stopping the external supply of water vapor, progressive heating of the condenser will again create water vapor that will then be returned to chamber 2 via recycling means 17: This water vapor will thus be dissociated and ionized. Advantageously, two water condensers will be installed in the enclosure such that one condenser will be brought to a low temperature to trap the water, while the other will be in heating phase to release the water vapor.

Device 20 according to the invention comprises a separation enclosure 14 preventing water from being sent in vapor form anywhere in chamber 2 (particularly on the walls). This separation enclosure is particularly useful when the water vapor is not introduced in plasma chamber 2 in the form of a directional jet.

FIG. 5 is a simplified representation of a device 100 for producing electron cyclotron resonance hydrogen according to a third embodiment of the invention.

The device 100 comprises:
a sealed vacuum plasma chamber;
four permanent bar magnets 103, 104, 105 and 106 placed outside chamber 102 (the bars typically have a height of between some centimeters and 1 m, for example 270 mm according to the embodiment described here);
a condenser 108 to trap the oxygen;
a pump 120 for pumping the gaseous hydrogen;
a non-dissociated water condenser 116 and recycling means 117;
means for injecting water vapor inside chamber 102 and means for propagating high-frequency waves inside chamber 102, said injection and propagation means being illustrated by arrow 111 and being located near magnet 104;
a screen 118 filtering the high-frequency waves;
protection means 119 against trapping water outside of chamber 102.

Chamber 102 is under vacuum, the vacuum being achieved by special pumping means.

The magnetic structure formed by the four bars 103, 104, 105, and 106 surrounding chamber 102 produces inside chamber 102 a magnetic field whose configuration is a magnetic mirror configuration presenting at least two magnetic field maxima and one magnetic field minimum and at least one resonance zone (here a plurality of resonance zones represented by white dots 21 located on field lines 112).

A microwave generator, not represented, is placed outside chamber 102; this generator sends high-frequency (HF) waves into chamber 102 via the aforementioned propagation means.

The means for injecting water vapor inside chamber 102 are preferentially placed near the microwave generator means. The water is introduced in plasma chamber 102 in vapor phase.

Thanks to the principle of electron cyclotron resonance, at every passage in the vicinity of the resonance zone, the electrons will acquire energy. They will then be able to dissociate the water molecules and then ionize, at least partially, the products of dissociation. Thanks to the electroneutrality of plasma, these ions will follow the electrons along magnetic field lines 112.

The water vapor is injected substantially following the vertical AA′ axis in the plane of the sheet by the injection means. Device 100 according to the invention comprises a separation enclosure 119 preventing water from being sent in vapor form anywhere in chamber 102 (particularly on the walls). This separation enclosure is particularly useful when the water vapor is not introduced in plasma chamber 102 in the form of a directional jet.

The non-dissociated water condenser 116 is cooled, for example with liquid nitrogen (at 77K) so as to set the water in ice form. The condenser 116 is arranged near magnet 105, in a straight line with relation to the water vapor injection axis AA′. Of course, the water may be kept in liquid form with a condenser at some ° C., the latter solution being more economical.

The 4 permanent magnet bars 103 (south polarity), 104 (north polarity), 105 (north polarity) and 106 (south polarity) are placed so that the poles with the same sign face each other. The magnetic inductions of all these magnets are equal in absolute value. The distance between magnets 104 and 103 being shorter than the distance between magnets 104 and 106, the magnetic field lines go from 104 to 103. The role of the magnets is to obtain magnetic field lines and to create ECR zones. In an example of embodiment for a microwave frequency of 2.45 GHz, the basic section of a magnet bar is close to 5.4 cm×6.5 cm. The height may vary from some centimeters to several meters. The water vapor is injected in the region of magnet 104 in the AA′ direction parallel to the magnetic field lines. The same is true for the microwaves. In this way, the water vapor that is not used in the plasma goes directly to H₂0 condenser 116 to be recycled via recycling means 117. The curvature of the field lines enables the non-dissociated water, hydrogen and oxygen to not be recovered in a same zone. Because of differences in condensation temperature of these elements, ice would accumulate, which would significantly decrease the effectiveness of the system until the machine is stopped.

Condenser 108, whose temperature is on the order of 20-30K, traps the oxygen from the plasma. Oxygen condenser 108 is, for example, a solid or openwork cryopanel (or cryogenic panel) arranged at the end of magnetic field lines 112. At this temperature, the hydrogen is not trapped, remains gaseous and may thus be pumped via pumping means 120. Regeneration cycles should then be carried out to evacuate the oxygen that accumulates over time on the cold wall of condenser 108.

It will be noted that device 100 according to the invention consists of a version of the invention where the magnetic field lines are significantly curved such that a central part with an almost flat field is obtained. This advantageous form enables good separation of the non-dissociated water that quickly leaves the plasma. FIG. 5 also shows that the number of resonance zones increases, which is advantageous for the processes of molecule dissociation and ionization of the atoms formed.

In addition, this disposition enables a catalyst to be placed on practically the entire length of the machine, as will be illustrated in FIG. 7.

In addition, it will be noted that there are also magnetic field lines that go from magnet 105 to magnet 106, also with resonance zones. Preferentially, the water recovery means 116 should not be found in a zone of dense plasma. To do this, the HF screen 118, whose mesh will be of a small size with relation to the wavelength of the microwaves injected, enables plasma to be obtained only in the zone desired. The mesh is chosen so as to prevent the propagation of microwaves while allowing water molecules to pass through.

FIG. 6 is a variation of the previous figure (the means in common between devices 100 and 200 bear the same reference numbers and carry out the same functions). Device 200 according to this fourth embodiment is differentiated from device 100 of FIG. 5 in that it comprises a cryogenic condenser system to trap the hydrogen. Here, this system is achieved in the form of two cold walls 207 and 213, whose temperature is less than 5K, that trap the hydrogen. Here also, the cold wall condenser 108 intended to trap the oxygen is located in the magnetic field lines 112 while the cold walls 207 and 213 intended to trap the hydrogen are placed outside of the magnetic field lines 112.

It will be noted that the HF screen is not represented in FIG. 6.

FIG. 7 represents in top view a fifth embodiment of a device 300 according to the invention. Device 300 is identical to device 200 from FIG. 6 (the means in common between devices 200 and 300 bear the same reference numbers and perform the same functions) and also comprises a catalyst surface 301 placed in a magnetic mirror zone, preferably between the resonance zones. This catalyst surface is intended to increase the effectiveness of the water dissociation and the ionization of the dissociated elements: It sets the water molecules to increase the water dissociation yield by electron impacts of the plasma on this surface.

Catalyst 301 is, for example, a Ti0₂-based surface. Considering the fact that catalyst 301 is placed not far from the plasma, the device according to the invention designed to dissociate water may advantageously be used for, first, surface treatment of the catalyst to increase its effectiveness: In this case, argon plasma will be used. This catalyst is placed close to the plasma so as to be able to benefit from a surface treatment in a first utilization phase of the machine. Then, the hydrophilic character of this catalyst will allow the input of water vapor into the machine to be regulated. Thus, the device will operate either with a non-dissociated H₂0 recovery system, or with a catalyst, or with a combination of the two methods for regulating the quantity of water in the device.

FIG. 8 represents in top view a sixth embodiment of the device 400 according to the invention. This device 400 is differentiated from device 200 of FIG. 6 in that it comprises:
four permanent magnets 403, 404, 405 and 406 such that the magnetization of magnet 403 (south pole) is 0.7 times lower than the magnetization of magnet 406 (south pole) that itself has a same magnetization as magnets 404 and 405 (two north poles);
a second cryogenic condenser 108′ to trap the oxygen;
a second cryogenic condenser system to trap the hydrogen made in the form of two cold walls 207′ and 213′.

The other means in common between device 200 according to FIG. 6 and device 400 according to FIG. 8 bear the same reference numbers.

Thanks to the magnetic structure formed by the four permanent magnets 403 to 406, field lines 212 are divided into two series 412 and 412′ of magnetic field lines so as to be able to alternatively recover hydrogen and oxygen in two different locations. To do this, the magnetization value of magnet 403 only has to be reduced in absolute value with relation to the magnetization of magnets 404, 405 and 406.

By virtue of the magnetization values chosen, field lines 412 and 412′ will go from magnet 404, in the region of which water vapor and microwaves are respectively injected, towards magnets 406 and 403.

Device 400 thus comprises two recovery enclosures 407 and 408.

Recovery enclosure 408 comprises:
two cold walls 207 and 213, whose temperature is less than 5K, that trap hydrogen.
the cold wall condenser 108 intended to trap the oxygen located, said condenser 108 intercepting the series of magnetic field lines 412 while cold walls 207 and 213 intended to trap the hydrogen are placed outside of the series of magnetic field lines 112. Recovery enclosure 407 comprises:
two cold walls 207′ and 213′, whose temperature is less than 5K, that trap hydrogen.
the cold wall condenser 108′ intended to trap the oxygen located, said condenser 108′ intercepting the series of magnetic field lines 412′ while cold walls 207′ and 213′ intended to trap the hydrogen are placed outside of the series of magnetic field lines 412′.

These two enclosures 408 and 407 are alternatively connected to plasma chamber 102, for example through a slide valve 414. Thus, while the condensers located in the region of enclosure 407 separately trap the particles, enclosure 408 is insulated from plasma chamber 102 to successively regenerate the two condensers: This regeneration process is first done by elevating the temperature from 5K to a temperature of less than 30K so that the hydrogen passes in gaseous phase and may be pumped, then by elevating the temperature to a temperature greater than 40K to pump the oxygen that has become gaseous.

The device 400 according to the invention here uses an example of plasma with 3 branches: The injection of water vapor and microwaves is done in one branch, then the plasma is divided into two branches where the hydrogen and oxygen recovery systems are placed.

FIG. 9 represents in top view a seventh embodiment of the device 500 according to the invention.

The device 500 comprises:
a sealed vacuum chamber 502;
six permanent bar magnets 503, 503′, 504, 505, 506 and 506′ placed outside of chamber 502; magnets 503 (south pole) and 506 (south pole) face each other on both sides of chamber 502; magnets 504 (north pole) and 505 (north pole) face each other on both sides of chamber 502; magnets 503′ (south pole) and 504′ (south pole) face each other on both sides of chamber 502;
means for injecting water vapor inside chamber 502 and means for propagating high-frequency waves inside chamber 502, said injection and propagation means being illustrated by arrow 511 and being located near magnet 504;
two recovery enclosures, not represented;
a non-dissociated water condenser 516.

Chamber 502 is under vacuum, the vacuum being achieved by special pumping means.

The magnetic structure formed by the six permanent magnets 503, 503′, 504, 505, 506 and 506′ surrounding chamber 502 produces inside chamber 502 a magnetic field whose configuration is a magnetic mirror configuration presenting at least two magnetic field maxima and one magnetic field minimum and at least one resonance zone (here a plurality of resonance zones represented by white dots 21 located on field lines 512 and 512′).

The six permanent magnets 503, 503′, 504, 505, 506 and 506′ are such that the magnetization of magnets 503 and 503′ (both having a south polarity) is 0.7 times weaker than the magnetization of magnets 504 and 505 (both having a north polarity) and magnets 506 and 506′ (both having a south polarity).

Thanks to the magnetic structure formed by the six permanent magnets 503, 503′, 504, 505, 506 and 506′, the field lines are divided into two series 512 and 512′ of magnetic field lines so as to recover the hydrogen and oxygen in two different locations thanks to the cryogenic traps that we will describe subsequently. To do this, the magnetization value of magnets 503 and 503′ only has to be reduced in absolute value with relation to the magnetization of magnets 505, 504, 506 and 506′. In so doing, the magnetic field lines are guided to the locations where the condensers have been placed. By virtue of the magnetization values chosen, field lines 512 and 512′ will go from magnet 504, in the region of which water vapor and microwaves are respectively injected, towards magnets 506 and 506′.

The first recovery enclosure comprises:
two cold walls 507 and 513, whose temperature is less than 5K, that trap hydrogen;
a cold wall condenser 508 intended to trap the oxygen located, said condenser 508 intercepting the series of magnetic field lines 512 while cold walls 507 and 513 intended to trap the hydrogen are placed outside of the series of magnetic field lines 512.

The second recovery enclosure comprises:
two cold walls 507′ and 513′, whose temperature is less than 5K, that trap hydrogen.
a cold wall condenser 508′ intended to trap the oxygen located, said condenser 508′ intercepting the series of magnetic field lines 512′ while the cold walls 507′ and 513′ intended to trap the hydrogen are placed outside of the series of magnetic field lines 512′.

Thanks to the principle of electron cyclotron resonance, at every passage in the vicinity of the resonance zone, the electrons will acquire energy. They will then be able to dissociate the water molecules and then ionize, at least partially, the products of dissociation. Thanks to the electroneutrality of plasma, these ions will follow the electrons along magnetic field lines 512 and 512′.

The non-dissociated water condenser 516 is cooled, for example with liquid nitrogen (at 77K) so as to set the water in ice form (as already explained previously, it is also possible and more economical to recover in liquid form at some ° C.). The condenser 516 is arranged near magnet 505, in a straight line with relation to the water vapor injection axis AA′. The water vapor is injected in the region of magnet 504 in the AA′ direction parallel to the magnetic field lines. The same is true for the microwaves. In this way, the water vapor that is not used in the plasma directly goes to H₂0 condenser 516 to be recycled via recycling means 517.

As in the case of FIG. 8, the two recovery enclosures may be alternately connected to plasma chamber 502, for example through a slide valve, not represented. Thus, while the condensers located in the region of the first enclosure separately trap the particles, the second enclosure is insulated from plasma chamber 502 to regenerate successively the two condensers.

FIG. 10 represents in top view an eighth embodiment of the device 600 according to the invention.

The device 600 comprises:
a sealed vacuum chamber 602;
six permanent bar magnets 603, 603′, 604, 605, 606 and 606′ placed outside of chamber 602; magnets 603 south pole) and 606 (south pole) face each other on both sides of chamber 602; magnets 604 (north pole) and 605 (north pole) face each other on both sides of chamber 602; magnets 603′ (south pole) and 604′ (south pole) face each other on both sides of chamber 602;
means for injecting water vapor in chamber 602 and means for propagating high-frequency waves inside chamber 602, said injection and propagation means being illustrated by arrow 611 and being located near magnet 604;
two oxygen condensers 608 and 608′ made in the form of cold walls arranged at the ends of magnetic field lines 612 and 612′;
two condensers 609 and 610 with cold walls for recovering hydrogen (at a temperature of less than 5K) located near the end of field lines 612′ but not intercepting field lines 612′.
a pump 613 for pumping gaseous hydrogen located near the end of field lines 612;
a catalyst surface 614 placed in the magnetic mirror zone, preferably between the resonance zones.

Chamber 602 is under vacuum, the vacuum being achieved by special pumping means (typically a residual vacuum of 0.1 Pa is sufficient).

The magnetic structure formed by the six permanent magnets 603, 603′, 604, 605, 606 and 606′ surrounding chamber 602 produces inside chamber 602 a magnetic field whose configuration is a magnetic mirror configuration presenting at least two magnetic field maxima and one magnetic field minimum and at least one resonance zone (here a plurality of resonance zones represented by white dots 21 located on field lines 612 and 612′).

The six permanent magnets 603, 603′, 604, 605, 606 and 606′ are such that they present a same magnetization and a same dimension.

Thanks to the magnetic structure formed by the six permanent magnets 603, 603′, 604, 605, 606 and 606′, field lines are divided into two series 612 and 612′ of magnetic field lines so as to recover hydrogen and oxygen in two different locations. By virtue of the magnetization values chosen, field lines 612 and 612′ will go from magnet 604, in the region from which water vapor and microwaves are injected, towards magnets 603 and 603′ (the lines go from north to south by the shortest path inasmuch as all the magnets have the same induction).

Thanks to the principle of electron cyclotron resonance, at every passage in the vicinity of the resonance zone, the electrons will acquire energy. They will then be able to dissociate the water molecules and then ionize the products of dissociation. Thanks to the electroneutrality of plasma, these ions will follow the electrons along magnetic field lines 612 and 612′.

In the case of device 600, the hydrogen is recovered in two different ways:

Thus, at field lines 612, condenser 608, whose temperature is on the order of 20-30K, traps the oxygen from the plasma. At this temperature, the hydrogen is not trapped, remains gaseous and may thus be pumped via pumping means 613.

In the region of field lines 612′, the plasma that follows these field lines thanks to its electroneutrality arrives close to wall 608′ whose temperature is near, for example, 20-30K. All the particles are thus trapped, except for the hydrogen, which will remain in gaseous phase. The two condensers 609 and 610 with cold walls (at a temperature of less than 5K and different from the temperature of condenser 608′) are placed outside the magnetic field lines to cryocondense the hydrogen.

Device 600 does not comprise a non-dissociated water condenser but comprises a catalyst surface 614 placed in the central zone of the magnetic mirror, preferably between the resonance zones and arranged in a straight line with relation to the water vapor injection axis AA′. This catalyst surface is intended to increase the effectiveness of the water dissociation and the ionization of the dissociated elements: It sets the water molecules to increase the water dissociation yield by electron impacts of the plasma on this surface. Consequently, one may consider that the majority of the water vapor will be dissociated and that a non-dissociated water recovery condenser is not necessary; however, the presence of the water recovery condenser improves the effectiveness of the device.

Device 600 also comprises means 615 to protect against trapping water outside chamber 102.

FIG. 11 represents in top view a ninth embodiment of a device 700 according to the invention.

Device 700 is substantially identical to device 500 of FIG. 9 (the means in common between devices 200 and 300 bear the same reference numbers and carry out the same functions); Device 700 is differentiated from device 500 in that it comprises two identical permanent magnets 704 and 705 (two north poles) instead of permanent magnets 504 and 505. Magnet 704 is found in the region of the water vapor and microwave injection 511. The width of magnets 704 and 705 was increased with relation to the widths of magnets 504 and 505. Consequently, the size of the resonance zone in the region of injection 511 in device 700 is larger than that of device 500.

By virtue of the layout, size and distance separating the different magnets 503, 506, 704, 705, 503′ and 506′, device 700 according to the invention enables a plasma with 5 branches to be generated: The injection of water vapor and microwaves is done in one branch, then the plasma is divided into four branches 712, 712′, 712″ and 712″′ where the hydrogen and oxygen recovery systems are placed.

Thus there are four hydrogen and oxygen recovery systems, each comprising:
two cold walls (respectively 507 and 513, 507′ and 513′, 707 and 713, 707′ and 713′) whose temperature is less than 5K, that traps the hydrogen.
a cold wall condenser (respectively 508, 508′, 708, 708′) intended to trap the oxygen located, said condenser intercepting the series (respectively 712, 712′, 712″, 712″′) of magnetic field lines while the cold walls intended to trap the hydrogen are placed outside of the series of magnetic field lines.

FIG. 12 represents in top view a tenth embodiment of a device 800 according to the invention. Device 800 is a complete system that occupies the entire plasma chamber. The microwave injections are multiple, as are the hydrogen recovery systems.

The device 800 comprises:
a sealed vacuum chamber 802;
six permanent bar magnets 803, 803′, 804, 805, 806 and 806′ placed outside of chamber 802 and presenting the same magnetization and the same dimensions; magnets 803 (south pole) and 806 (south pole) face each other on both sides of chamber 602 at one end of the latter; magnets 804 (north pole) and 805 (north pole) face each other on both sides of chamber 902 in the center of the latter; magnets 803′ (south pole) and 804′ (south pole) face each other on both sides of chamber 602 at the other end of the latter;
first means for injecting water vapor inside chamber 802 and means for propagating high-frequency waves inside chamber 802, said first injection and propagation means being illustrated by arrow 811 and being located near magnet 806′;
second means for injecting water vapor inside chamber 802 and means for propagating high-frequency waves inside chamber 802, said second injection and propagation means being illustrated by arrow 811′ and being located near magnet 803′;
third means for injecting water vapor inside chamber 802 and means for propagating high-frequency waves inside chamber 802, said third injection and propagation means being illustrated by arrow 811″ and being located near magnet 803;
fourth means for injecting water vapor inside chamber 802 and means for propagating high-frequency waves inside chamber 802, said fourth injection and propagation means being illustrated by arrow 811″′ and being located near magnet 806;
a first oxygen condenser 808 made in the form of cold walls arranged at the end of magnetic field lines 812′ and 812″;
a second oxygen condenser 808′ made in the form of cold walls arranged at the end of magnetic field lines 812 and 812″′;
a first pump 813 for pumping gaseous hydrogen located near the lines of the end of field lines 812′ and 812″;
a second pump 813′ for pumping gaseous hydrogen located near the lines of the end of field lines 812 and 812″′;
four catalyst surfaces 814, 814′, 814″ et 814″′ placed in the central zone of the magnetic mirror.

Thanks to the magnetic structure formed by the six permanent magnets 803, 803′, 804, 805, 806 and 806′, device 800 according to the invention enables a plasma with 6 branches to be generated: The water vapor and microwave injection is done in the four branches 812, 812′, 812″ and 812″′ in the region, the two branches 812′ et 812″ meeting at the location where the hydrogen and oxygen recovery systems 808 and 813 are placed and the two branches 812 and 812″ meeting at the location where the hydrogen and oxygen recovery systems 808′ and 813′ are placed.

It will be noted that device 800 does not comprise a non-dissociated water condenser but comprises four catalyst surfaces 814, 814′, 814″ et 814″′ intended to increase the effectiveness of the water dissociation and the ionization of dissociated elements. It will also be noted that device 800 comprises two non-dissociated water recycling systems (in small quantity by virtue of the presence of catalyst surfaces), each utilizing a recycling pump 815 and 815′.

Of course, the invention is not limited to the embodiment that has just been described.

Thus, if one wishes to process a greater quantity of water, it is possible to increase the dimensions of the equipment while ensuring resonance zones in the plasma chamber.

In addition, it is possible to use magnetic field coils (superconducting or not) to create more intense fields.

Even if the invention was more particularly described for a resonance frequency at 2.45 GHz, higher frequency microwaves may, of course, be utilized.

As we have also noted, for some applications and/or for more effectiveness of the device, multiplying the number of plasma branches is quite possible. In this way, it is possible to have a device according to the invention comprising:
either several hydrogen (in gaseous phase or not) and oxygen recovery systems;
or several water recovery systems;
or several catalysts;
or several injection (microwave and/or water vapor) systems; These systems may be utilized in combination with each other.

1. A device (1) for producing hydrogen from electron cyclotron resonance plasma comprising:
a sealed vacuum chamber (2) intended to contain plasma,
means (11) for injecting water vapor into said chamber (2),
means (11) for injecting a high-frequency wave inside said chamber (2),
a magnetic structure (3, 4, 5, 6) for generating a magnetic field in said chamber (2) and generating a plasma surface along the magnetic field lines (12), the module of said magnetic field presenting a magnetic mirror configuration with at least one electron cyclotron resonance zone (21) to at least partially dissociate the water molecules introduced in vapor phase and to at least partially ionize the products of dissociation,
said device (1) being characterized in that it comprises:
at least one cryogenic condenser (8), placed in said sealed chamber (2) to freeze the oxygen coming from the dissociation without freezing the hydrogen coming from the dissociation,
means (7, 13) for recovering the hydrogen coming from the dissociation, the oxygen being trapped by said cryogenic condenser (8).

2. The device (1) according to the previous claim characterized in that the device comprises means (9) to recover the non-dissociated water, the field lines generated by said magnetic structure being curved with relation to the axis of injection of the water vapor, said non-dissociated water recovery means (9) being substantially arranged along the axis (AA′) of injection of the water vapor.

3. The device (1) according to claim 2 characterized in that said non-dissociated water recovery means (9) comprise a second chamber (9) connected to said plasma chamber.

4. The device (20) according to claim 2 characterized in that said non-dissociated water recovery means are formed by a condenser (16).

5. The device according to one of claims 2 to 4 characterized in that said non-dissociated water recovery means are separated from said plasma chamber by a diaphragm device.

6. The device (1) according to one of claims 2 to 5 characterized in that the device comprises at least one system (10) for reinjecting the non-dissociated water in vapor phase and coming from said non-dissociated water recovery means (9).

7. The device (100) according to one of claims 2 to 6 characterized in that the device comprises a screen (118) presenting a mesh allowing the propagation of high-frequency waves to be stopped such that said non-dissociated water recovery means (116) are arranged in a zone substantially without plasma.

8. The device (1) according to one of the previous claims characterized in that said cryogenic condenser (1) to freeze the oxygen coming from the dissociation without freezing the hydrogen coming from the dissociation is at a temperature of between 6 and 41K for an average pressure of between 10⁻³ mbar and 5·10⁻³ mbar in said chamber (2).

9. The device (1) according to one of the previous claims characterized in that said cryogenic condenser (8) to freeze the oxygen is a solid or openwork cryogenic panel.

10. The device (1) according to one of the previous claims characterized in that said cryogenic condenser (8) to freeze the oxygen is arranged so as to intercept said field lines (12) formed by said magnetic structure (3, 4, 5, 6).

11. The device according to one of the previous claims 1 to 9 characterized in that said cryogenic condenser to freeze the oxygen is a cryogenic panel that surrounds said field lines formed by said magnetic structure.

12. The device according to one of the previous claims characterized in that the device comprises an enclosure able to recover oxygen when said cryogenic condenser to freeze the oxygen is regenerated by increasing the temperature.

13. The device (100) according to one of the previous claims characterized in that said means (120) to recover the hydrogen coming from the dissociation comprise a pump used to pump the hydrogen in gaseous phase.

14. The device (1) according to one of the previous claims characterized in that said means (7, 13) to recover hydrogen coming from the dissociation comprise at least one cryogenic condenser to freeze hydrogen, said cryogenic condenser being at a temperature less than the temperature of said at least one cryogenic condenser to freeze the oxygen, said at least one cryogenic condenser to freeze the oxygen being arranged so as to trap the oxygen before said at least one cryogenic condenser to freeze the hydrogen traps the hydrogen.

15. The device according to the previous claim characterized in that the device comprises:
a cryogenic condenser to freeze the hydrogen able to be regenerated by increasing the temperature;
an enclosure able to recover the hydrogen when said cryogenic condenser to freeze the hydrogen is regenerated by increasing the temperature.

16. The device (400) according to claim 15 characterized in that the device comprises:
a first enclosure (408) including:
a first cryogenic condenser (108) to freeze the oxygen;
a first cryogenic condenser (207, 213) to freeze the hydrogen;
a second enclosure (407) including:
a second cryogenic condenser (108′) to freeze the oxygen;
a second cryogenic condenser (207′, 213′) to freeze the hydrogen;
each of said first and second enclosures (408, 407) being able to recover oxygen and hydrogen independently from each other by regeneration, said regeneration is done by progressive increase in the temperature so that the hydrogen first passes in gaseous phase and is recovered and the oxygen then passes into gaseous phase and is recovered.

17. The device according to one of claims 14 to 16 characterized in that said at least one cryogenic condenser to freeze the hydrogen comprises at least one solid or openwork cryogenic panel.

18. The device according to one of claims 14 to 17 characterized in that the device comprises a polarized screen placed in front, with relation to the plasma, of said at least one cryogenic condenser to freeze the hydrogen and/or said at least one cryogenic condenser to freeze the oxygen.

19. The device according to one of claims 14 to 17 characterized in that said at least one cryogenic condenser to freeze the hydrogen and/or said at least one cryogenic condenser to freeze the oxygen are able to be negatively polarized to push the electrons towards the plasma.

20. The device (1) according to one of the previous claims characterized in that said means (7, 13) to recover the hydrogen coming from the dissociation are arranged to not intercept said magnetic field lines (12).

21. The device (300) according to one of the previous claims characterized in that the device comprises at least one catalyst surface (301) to set the water molecules and increase the yield of water dissociation by electron impact of the plasma on said surface.

22. The device (300) according to the previous claim characterized in that said catalyst surface (301) is placed in the magnetic mirror zone, preferably between the resonance zones.

23. The device (1) according to one of the previous claims characterized in that said magnetic structure comprises permanent magnets (3, 4, 5, 6).

24. The device (1) according to claim 23 characterized in that the magnetic structure comprises permanent magnets (4, 5) whose poles, that face each other in the water vapor injection zone, are of the same type.

25. The device according to one of claims 23 to 24 characterized in that the magnetic structure comprises permanent magnets in which the poles facing each other in the hydrogen recovery zone have the same direction, the magnetization values of these magnets being either identical or different.

26. The device according to one of claims 23 to 24 characterized in that the magnetic structure comprises permanent magnets whose poles, that face each other in the hydrogen recovery zone, have opposite directions.

27. The device according to one of claims 23 to 26 characterized in that the permanent magnet located in the water vapor injection zone has the same polarity as the magnet located in the hydrogen recovery zone.

28. The device according to one of claims 23 to 27 characterized in that the magnetic structure comprises permanent magnets of different sizes and presenting either a same magnetization or different magnetizations.

29. The device according to one of the previous claims characterized in that the magnetic structure comprises coils at ambient temperature and/or superconducting coils at low or high critical temperature, called low or high Tc.

30. The device according to one of the previous claims characterized in that the entrance window of said high-frequency wave propagation means inside said chamber is placed in a magnetic field whose module is greater than the module of the magnetic resonance field so that the plasma diffuses towards the chamber and thus prevents the impact of plasma on said window.

31. The device according to one of the previous claims characterized in that the mirror ratio between the magnetic field maximum of said magnetic mirror and the magnetic field minimum of said magnetic mirror is strictly greater than 1 and preferentially greater than 3.
